(19) United States
(12) Patent Application Publication
(10) Pub. No.: US 2012/0249546 A1
(43) Pub. Date: Oct. 4, 2012

(54) METHODS AND SYSTEMS FOR VISUALIZATION AND ANALYSIS OF SUBLOBAR REGIONS OF THE LUNG

(75) Inventors: Juerg Tschirren, Iowa City, IA (US); Susan A. Wood, Palo Alto, CA (US)

(73) Assignee: VIDA DIAGNOSTICS, INC., Coralville, IA (US)

(21) Appl. No.: 13/439,387

(22) Filed: Apr. 4, 2012

Related U.S. Application Data
(60) Provisional application No. 61/471,677, filed on Apr. 4, 2011.

(51) Int. Cl. G06T 15/00

(52) U.S. Cl. 345/419

(57) ABSTRACT

Methods and systems for displaying a volumetric model of a patient's lung including sublobar regions. The system may include a processor and software operable on the processor to receive data from multi-dimensional images of the patient's lungs, such as CT images, and produce data for creation of a volumetric model of the patient's lungs, including sublobar regions, on a graphical user interface. The system may also display the multi-dimensional images on the graphical user interface. A user may select an airway location in the airways on the volumetric model or a multi-dimensional image on the graphical user interface and the portion of the lung distal to the selected location, which may be a sublobe, may be highlighted and/or characterized by the system.

### PRIORITY CLAIM

The present application claims priority to U.S. Provisional Patent Application No. 61/471,677, filed Apr. 4, 2011, the disclosure of which is hereby incorporated by reference in its entirety.

### BACKGROUND

In recent years medical imaging technology, examples of which include Magnetic Resonance Imaging (MRI) and Computed Tomography (CT) scanning, has been employed to construct patient-specific data bases, from which geometrical three-dimensional models, for example, representative of a structure of one or more organs of a body of the patient, may be generated. Such a model of a bodily structure, for a particular patient, can be employed as a reference during an invasive procedure performed on the patient, for diagnostic and/or treatment purposes.

Three-dimensional models of the lungs are able to provide images of the airways and surrounding lung tissue, but have not provided the depth of information which would be useful to clinicians, particularly at the sublobar level. Furthermore, in many disease conditions, the lungs are not uniformly affected. For example, chronic obstructive pulmonary disease (COPD), interstitial disease, and asthma, may affect certain areas of the lungs more than others. Knowledge about the localization of lung lesions is also of importance to guide further diagnostic tests, bronchoscopy or surgery. Current three dimensional imaging models do not adequately inform clinicians about distinct portions of the lungs, particularly with regard to disease conditions which affect the lungs at the sublobar level and/or in a non-uniform manner.

### SUMMARY

The systems as described in various embodiments provide a volumetric model of a patient's lungs. The system may include a processor and software operable on the processor. The software is operable to receive data from multi-dimensional images of the patient's lungs such as CT scan data and to produce data for creation of a volumetric model of the patient's lungs on a graphical user interface. The volumetric model includes sublobar airways and is therefore very useful for characterizing the lungs and for treatment planning, for example.

The software may be further operable to display a multi-dimensional image of the lungs on the graphical user interface, or to display three orthogonal multi-dimensional images of the lungs on the graphical user interface, such as 3 orthogonal planar CT images. In some embodiments, the system allows a user to select a location on the volumetric model, and the system can highlight the portion of the lung distal to the user selected location on the volumetric model and/or on the multi-dimensional images, and this portion of the lung may be a sublobe. In some embodiments, the system may allow a user to select a location on one of the multi-dimensional images of the lungs, and may highlight, on the volumetric model and/or on the multi-dimensional images, the portion of the lung distal to the user selected location, and the portion of the lung may be a sublobe.

In some embodiments, a user may select a location on the volumetric model or on a multi-dimensional image on the graphical user interface, and the system may highlight an associated region of the lung distal to the selected location in the model and in each of the multi-dimensional images shown on the graphical user interface. The system may further provide data on the graphical user interface regarding the highlighted region of the lung, such as the volume and/or density of the highlighted region of the lung.

In some embodiments, the system may be used to evaluate a proposed treatment. For example, the system may allow a user to select a location on the volumetric model or on one of the multi-dimensional images as a location of a proposed therapy, such as the placement of a one-way valve. In some embodiments, the system allows a user to select a location as a bronchoscopy target on the volumetric model or on one of the multi-dimensional images.

In some embodiments, a computer readable medium comprises machine readable instructions for receiving data corresponding to multi-dimensional images of a patient's lungs, generating a volumetric model of the patient's airway using the data, the volumetric model including distinct sublobar regions, and displaying the volumetric model on a graphical user interface. The computer readable-medium may also include instructions for displaying multi-dimensional images of the patient's lungs on the graphical user interface. In some embodiments, the computer readable medium also includes instructions for receiving user input identifying a location on the volumetric model or on a multi-dimensional image on the graphical user interface, altering the volumetric model to highlight a portion of the airway tree, that portion being all of the airway distal to the user identified location and being a sublobe, and altering the multi-dimensional images to highlight that portion of the airway tree. The computer readable medium may also include instruction for calculating data corresponding to that portion of the airway tree such as volume and/or density data and displaying the data on the graphical user interface.

Embodiments also include methods of visualizing a sublobe of a patient's lung. The method can include providing multi-dimensional imaging data of the patient's lungs to a system, the system including a graphical user interface, a processor, and software operable on the processor. The software may be adapted to receive the multi-dimensional imaging data and produce data for creation of a volumetric model of the patient's lungs including sublobar airways on the graphical user interface. The method may also include selecting a location on the volumetric model, wherein the system is adapted to highlight a portion of the lung which is distal to the user selected location on the volumetric model on the graphical user interface, with the highlighted portion of the lung being a sublobe. The system may be further adapted to provide data on the graphical user interface regarding the highlighted region of the lung.

### BRIEF DESCRIPTION OF THE DRAWINGS

The following drawings are illustrative of particular embodiments of the invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a screenshot of a graphical user interface according to embodiments of the invention;

FIG. 2 is a screenshot of a graphical user interface with a sublobar portion highlighted according to embodiments of the invention;

FIG. 3 is a screenshot of a graphical user interface showing a bronchoscopy pathway according to embodiments of the invention; and

FIG. 4 is a screenshot of a graphical user interface with multiple sublobar portions highlighted according to embodiments of the invention.

### DETAILED DESCRIPTION

The following detailed description is exemplary in nature and is not intended to limit the scope, applicability, or configuration of the invention in any way. Rather, the following description provides practical illustrations for implementing exemplary embodiments. Utilizing the teaching provided herein, those skilled in the art will recognize that many of the examples have suitable alternatives that can be utilized.

Embodiments of the invention provide volumetric models of the lungs including information regarding discrete sublobar regions. These volumetric models can be used by physicians to better understand and assess lung anatomy and disease conditions, particularly disease conditions which are non-homogenous and which may affect certain portions of the lung more than others. It can further be used to evaluate the effect of proposed interventions on certain portions of the lungs. Furthermore, because this information is provided in the form of a 3-dimensional volumetric model, it can be easily visualized and understood by a physician, who can interact with the model to display the desired information.

An understanding of the branching airway structure of the lungs (the bronchial tree) is useful to describing embodiments of the invention. The airway structure begins with branching of the trachea into the right and left bronchi which ventilate the right and left lungs. The right bronchus divides into three lobar bronchi which ventilate the three lobes in the right lung (the right upper lobe, right middle lobe, and right lower lobe) and the left bronchus divides into two lobar bronchi with ventilate the two lobes in the left lung (the left upper lobe and the left lower lobe). The lobar bronchi further divide into multiple tertiary bronchi or segmental bronchi, each of which ventilates a pulmonary segment. The tertiary bronchi then further branch into multiple primary bronchioles, which each ventilate multiple secondary lobules. The branching of the bronchial tree continues as the primary bronchioles branch into terminal bronchioles, then respiratory bronchioles, alveolar ducts, and finally alveolar sacs. The term “sublobar airway” as used herein therefore refers to airways which are smaller than the lobar bronchi, including the tertiary bronchi, primary bronchioles, terminal bronchioles and/or smaller airways. Similarly, the term “sublobe” as used herein refers to segments, secondary lobules, and/or smaller lung portions.

Embodiments of the invention use data obtained from multi-dimensional imaging modalities to construct a volumetric structural model of the lungs. The multi-dimensional imaging modalities which may be used include but are not limited to CT scans, MRI scans, and PET scans, from which series of 2 dimensional planar images can be produced in multiple planes. For example, volumetric model of a bronchial tree structure can be generated from a volumetric data set from a CT scan or other multi-dimensional scan of a patient. The model may be generated from the volumetric data set of the images collected via CT scanning of the bronchial tree, for example, according to methods employed by the Pulmonary Workstation of Vida Diagnostics, Inc. (Iowa City, Iowa) and described in the following references, each of which is incorporated herein by reference: United States Patent Publication 2007/0092864, which is entitled: TREATMENT PLANNING METHODS, DEVICES AND SYSTEMS; United States Patent Publication 2006/0030958, which is entitled: METHODS AND DEVICES FOR LABELING AND/OR MATCHING; Tschirren et al., Intrathoracic airway trees: segmentation and airway morphology analysis from low-dose CT scans. IEEE Trans Med Imaging. 2005 December; 24 (12):1529-39; Tschirren et al., Matching and anatomical labeling of human airway tree. IEEE Trans Med Imaging. 2005 December; 24 (12):1540-7; Tschirren, Juerg, Segmentation, Anatomical Labeling, Branchpoint Matching, and Quantitative Analysis of Human Airway Trees in Volumetric CT Images, Ph.D. Thesis, The University of Iowa, 2003; Tschirren, Juerg, Segmentation Anatomical Labeling, Branchpoint Matching, and Quantitative Analysis of Human Airway Trees in Volumetric CT Images, Slides from Ph.D. defense, The University of Iowa, 2003; and Li, Kang, Efficient Optimal Net Surface Detection for Image Segmentation—From Theory to Practice, M. Sc. Thesis, The University of Iowa, 2003. Although systems and methods are described herein in the context of a bronchial tree, it should be appreciated that the systems and methods may be applied to any branched structure of a body. It should also be understood that the volumetric model is not truly created volumetrically, because it exists on a flat 2-dimensional visual display. Rather, the volumetric model uses perspective and shading, with the closest portions depicted in the foreground and more distant portions in the background along with the ability of the user to rotate the model, to show the entire volumetric volume on the visual display. In contrast, each image in the series of the multi-dimensional images provided by CT and MRI scans, for example, is a 2-dimensional planar image that depicts the tissue present in a single plane or slice. These images are typically acquired in three orthogonal planes, which are referred to as the three orthogonal views and are typically identified as being axial, coronal and sagittal views.

Embodiments of the invention allow the clinician to interact with the volumetric model and the multi-dimensional images associated with and used to generate the model. For example, the volumetric model and associated multi-dimensional images may be presented in a graphical user interface on a visual display. The user may interact with the graphical user interface to select a button, icon, or a location on the images or the airway model or elsewhere using a mouse, stylus, keypad, touchscreen or other type of interface known to those of skill in the art. The creation of the volumetric model may be performed by a system including a processor with software (computer readable media) to perform this function as well as software to permit a user to interact with the graphical user interface, to calculate and display desired data and images, and to perform the other functions described herein. The system may further include the visual display on which the graphical user interface is displayed.

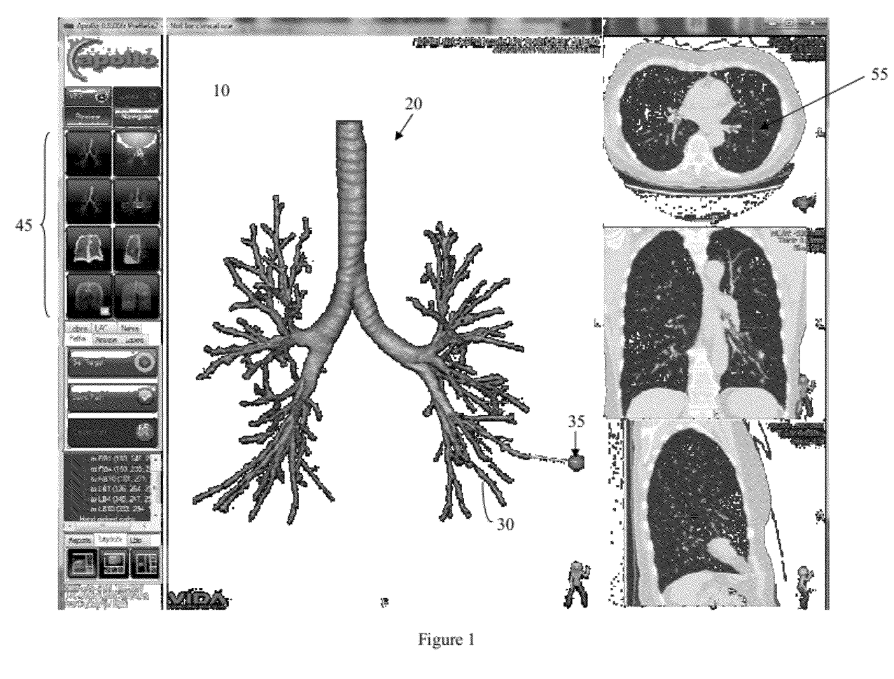

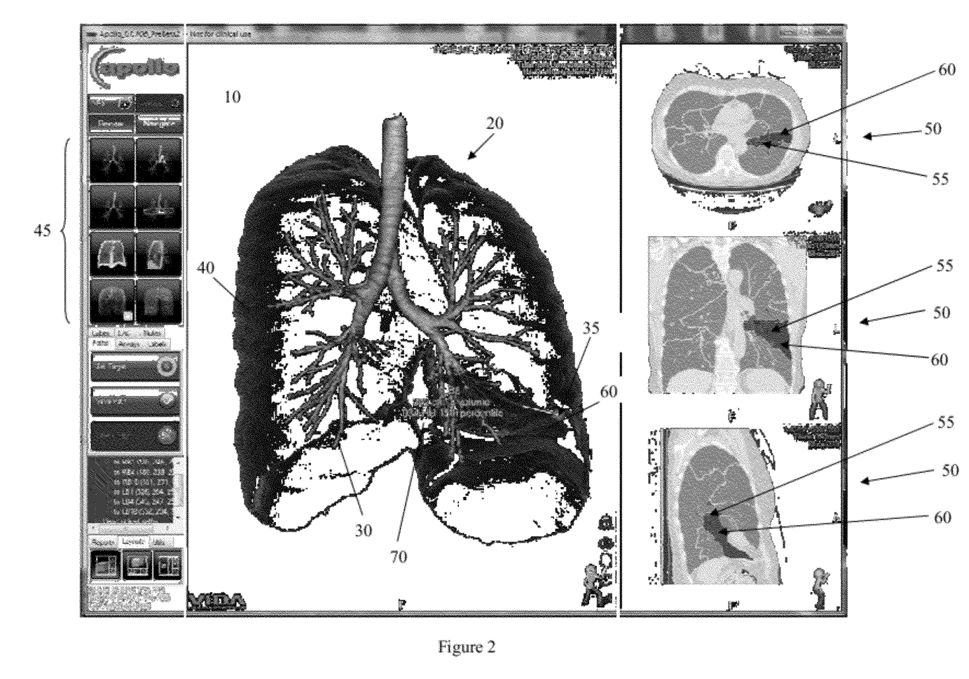

The volumetric model can be provided to a user (such as a clinician or researcher) as a graphical user interface on a visual display, which may be a computer screen, on which the image and data presented can be manipulated by the user. An example of a graphical user interface according to embodiments of the invention is shown in the screenshot reproduced in FIG. 1. The graphical user interface 10 includes a volumetric model 20 of the bronchial tree of a patient, including the sublobar airways 30. The volumetric model 20 may include not only the branching airways but also the lung parenchyma 40, as shown in FIG. 2, for example. In some embodiments, the user can select whether or not the volumetric model 20 shows the lung parenchyma 40, such as by selecting the desired view using one of various view icons 45, for example.

The volumetric model can further include labels to identify locations and structures in the bronchial tree. The labels may be based on anatomical identifications, or names for branches of the airway tree structure, and may have been assigned to branch points of the predetermined points of the model via methods described in the aforementioned patent publication '958, which is incorporated by reference. In some embodiments, the user can select whether or not to display the airways labels.

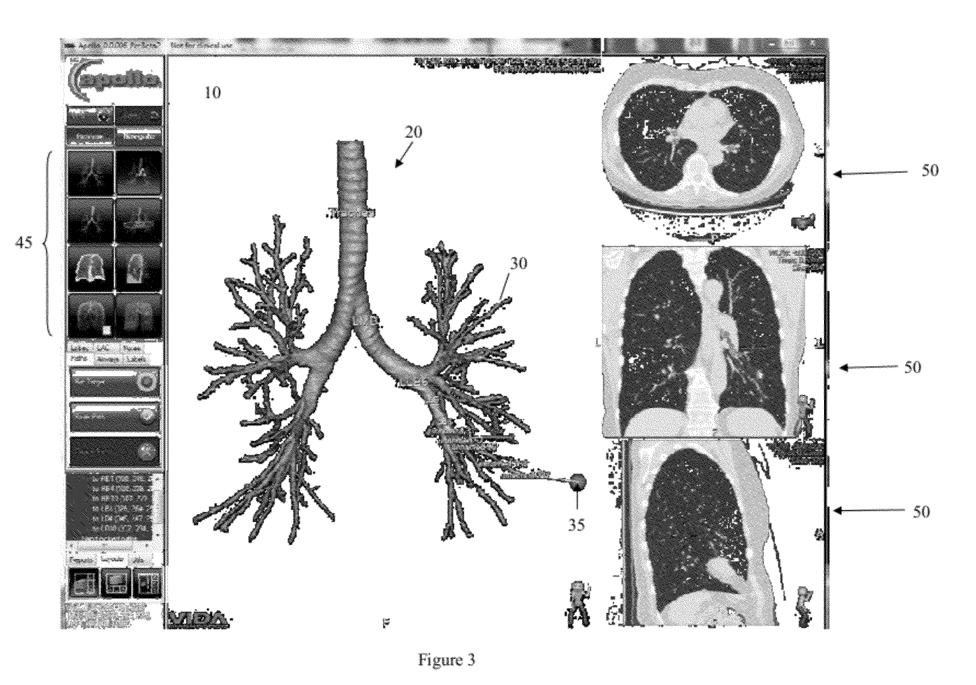

In addition, in some embodiments, one, two, or three corresponding multi-dimensional images such as CT images 50 can be displayed, such as in the three orthogonal views, along with the volumetric model 20 of the bronchial tree, as shown in FIG. 3, for example. The user can scroll through the associated CT images for each view (axial, coronal and sagittal) on the interface 10. For example, the user can select a CT image by clicking on the image on the interface 10 with a mouse and then may replace that image with the next image before or after in the CT series by scrolling up or down on the mouse wheel. The user can continue to scroll up and down through the images as desired.

The volumetric model 20 can also allow a user to visualize the bronchial tree at a sublobar airway level, such as at the level of the tertiary bronchi (the lung segments) or the primary bronchioles (the secondary lobules) and smaller airways. For example, the user may select a location on one, two, or all three of the CT images 50, such as by moving a cross hairs 55 or other marker to a location of interest and by clicking on the image with a mouse. The selected location may then be indicated on the volumetric model 20. In FIGS. 1, 2 and 3, the selected location is shown as a colored dot 35 but any contrasting and visible marking could be used. The portion of the bronchial tree which is distal to the selected location may be highlighted on the volumetric model 20 and/or on the one, two, or three of the corresponding multi-dimensional CT images 50. For example, the distal portion of the volumetric model 20 and the CT image 50 may be a sublobe, for example, and may be distinguished or highlighted by a shading or color or outline, for example, which is distinct from the remaining image. The same distinct color or shading or outline may be used in the volumetric model 20 as in each CT image 50. In this way, the user can easily see the selected sublobar portion in the volumetric model 20 as well as in each of the 3 planes of the CT images 50.

In addition, the user may interact with the multi-dimensional images 50 in order to obtain data regarding a selected portion of the lungs, such as a sublobe. The portion of the lung may be selected by the user by selecting a location on one, two or all three of the CT images 50, which may then be indicated on the volumetric model 20 as described above, for example. The system may then calculate and display on the graphical user interface 10 data regarding the selected lung portion, such as the volume and density for the selected portion. The selected lung portion may, at the same time, be distinguished as described above, to clearly inform the user the portion of the lung to which the data corresponds. This data may be used for diagnosis or characterization of a disease condition, for example.

For diseases which do not affect the lungs homogeneously, the ability to obtain data regarding small portions of the lung is particularly useful. Examples of such diseases include COPD, emphysema, asthma, interstitial lung disease, and lung cancer. The data regarding specific lung portions may allow a clinician to plan specific targeted therapies for portions of the lung, rather than global treatment of the entire lung which would otherwise involve tissue for which such treatment may not be needed. An understanding of the lungs at a smaller, sublobar level may also aid the clinician in characterizing the disease, such as identifying specific disease phenotypes and therefore developing more individualized treatments, and monitoring its progression or its response to therapy in specific areas such as sublobes, rather than globally, which may be too imprecise. Treating small segments of the lung with emphysema using lung volume reduction techniques, for example, enables maximal preservation of working lung and the elimination of hyperinflated, destructed regions.

In the graphical user interface 10 shown in FIG. 2, a user has selected a location in the bronchial tree as shown by dot 35 and the sublobar portion 60 of the lung distal to the selected location is shown in a contrasting color in each of the volumetric model 20 and the CT images 50. In addition, data 70 corresponding to the sublobar portion 60 is also shown. This data includes the volume and density of the sublobar portion 60.

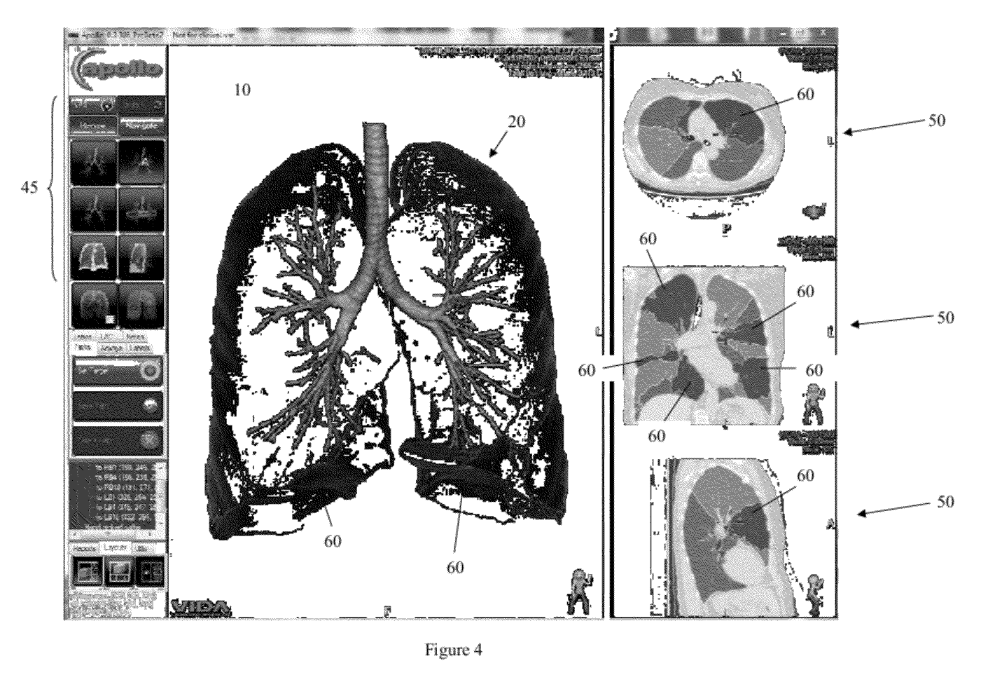

In some embodiments, the CT images 50 and/or the volumetric model can be highlighted to distinguish various sublobar portions, such as two, three, four or five separate portions of the lungs. In some embodiments, each separate portion may be highlighted or distinguished from the rest of the bronchial tree, such as by the use of a distinct color or shading or outlining for some or each portion which may be used identically in the volumetric model 20 as well as in each of the 2-dimension CT images 50. In this way, the user can visualize and distinguish multiple lung regions and easily identify corresponding regions in each view. An example of this is shown in FIG. 4, in which multiple sublobar regions 60 are each highlighted by a distinct color in the volumetric model 20 and in the corresponding CT images 50. This aids the user in visualizing each distinct portion of the lung in each view.

In some embodiments, the volumetric model 20 may be used for mapping a pathway within the bronchial tree, such as for planning bronchoscopy to a specific location within the lung. The user may select a target location on one, two or all three CT images 50 and the system can generate a pathway to the location which may be indicated on the volumetric model 3, as well as on each of the multi-dimensional CT images 50 by the use of a contrasting color, for example. By visualizing the pathway in this way, the user can plan the procedure and anticipate the anatomy and any potential difficulties that will be encountered during the bronchoscopy. An example of a volumetric model 20 showing a planned bronchoscopy path is reproduced in FIG. 3. In this example, the software has automatically labeled the airway tree along the pathway to the destination. The target may be a lesion of interest, such as a mass or diseased tissue, for which biopsy may be desired. The system can determine and display a pathway for the clinician to follow during a subsequent bronchoscopy in order to reach the lesion.

In some embodiments, the system includes software that can be used to plan a targeted and personalized therapeutic intervention. For example, in certain disease conditions such as chronic obstructive pulmonary disease and lung cancer, it may be desirable to apply a therapy or surgical procedure to only a portion of the lung, such as a sublobar region. One example of such a targeted therapy is the placement of a one way valve within an airway to close off the distal portion of the lung. Alternatively, the therapy may collapse a portion of the lung using steam, vapor, chemical, adhesives or other techniques known in the art. Other localized therapies include the placement of a stent within an airway to maintain ventilation to a proximal portion of the lung for treatment of bronchial cancers that impede airflow. Another example is as a surgical planning tool to guide a procedure such as the biopsy, resection or ablation of a suspicious lung nodule, such as ablation using a microwave device. Embodiments of the invention allow a user to assess the predicted impact of such therapies. For example, a user may select a location on the volumetric model of the bronchial tree 20 or on a multi-dimensional image 50 for the implementation of a selected therapy, such as the placement of a one-way valve. The system may then calculate and display data regarding the portion of the lung distal to the selected location. In this way, the most appropriate location for the therapy can be selected.

In embodiments in which a user is planning the placement of a one way valve within an airway, the user may select the location for placement of the valve on the volumetric model or on the multidimensional images. The selected location may be shown on the images by a marking such as a dot or other symbol. The affected area, such as a sublobar region, may then be shown in a contrasting color on the volumetric model and on each of the multi-dimensional images.

In some embodiments, the user may select a first location on the volumetric model or on a CT image for a treatment, such as the placement of a one-way valve, and the system may provide data regarding the portion of the lung, such as the sublobe, distal to the first location. The user may then choose a second location for the treatment, such as a location which is proximal or distal to the first location and along the same airway path or along a separate airway, and the system may provide data regarding the portion of the lung, such as the sublobe, distal to the second location. The user may then compare the images and data from the first location and the second location to make a treatment decision, such as selecting either the first or the second location as the location for the treatment or choosing not to apply the treatment at either location. Alternatively, the user may select additional locations, such as third or fourth locations, and obtain data and images for those locations, all of which may be compared before making a treatment decision. For example, decreased density values can correlate with increased disease severity in chronic obstructive pulmonary disease. Therefore, the density measurements for lung tissue distal to selected locations may be compared in order to select the location for therapy. The selected location may be the location for which the tissue has the lowest density.

It should be understood that any portion of the lung can be distinctly visualized and characterized from the entire lung down to the limits of the resolution of the multi-dimensional images. For example, current CT imaging, under standard conditions, allows characterization of airways and lung tissue having a diameter as small as approximately 1 millimeter or 2 millimeters. However, by adjusting the conditions, data can be obtained from even smaller lung portions and it is anticipated that continued advances in imaging technology will allow for even greater image resolution and therefore characterization of the lungs and airways of an even smaller size.

In the foregoing detailed description, the invention has been described with reference to specific embodiments. However, it may be appreciated that various modifications and changes can be made without departing from the scope of the invention as set forth in the appended claims.

1. A system for providing a volumetric model of a patient's lungs, the system comprising:
a processor;
software operable on the processor, wherein the software receives data from multi-dimensional images of the patient's lungs and produces data for creation of a volumetric model of the patient's lungs on a graphical user interface, wherein the volumetric model includes sublobar airways.

2. The system of claim 1 wherein the system allows a user to select a location on the volumetric model, and wherein the system can highlight a portion of the lung distal to the user selected location on the volumetric model, wherein the portion of the lung is a sublobe.

3. The system of claim 1 wherein the software is further operable to display a multi-dimensional image of the lungs on the graphical user interface.

4. The system of claim 1 wherein the software is further operable to display three orthogonal multi-dimensional images of the lungs on the graphical user interface.

5. The system of claim 4 wherein the system allows a user to select a location on one of the multi-dimensional images of the lungs, and wherein the system can highlight on the volumetric model a portion of the lung distal to the user selected location, wherein the portion of the lung is a sublobe.

6. The system of claim 5 wherein the system can further highlight on one or more of the multi-dimensional images the portion of the lung distal to the user selected location.

7. The system of claim 6 wherein the user may select a location on the model and the graphical user interface will highlight an associated region of the lung distal to the selected location in the model and in each of the multi-dimensional images.

8. The system of claim 7 wherein the system can further provide data on the graphical user interface regarding the highlighted region of the lung.

9. The system of claim 6 wherein the data comprises volume and/or density of the highlighted region of the lung.

10. The system of claim 4 wherein the system allows a user to select a location on the volumetric model or on one of the multi-dimensional images as a location of a proposed therapy.

11. The system of claim 10 wherein the proposed therapy is the placement of a one-way valve.

12. The system of claim 4 wherein the system allows a user to select a location on the volumetric model or on one of the multi-dimensional images as a bronchoscopy target.

13. A computer readable medium comprising machine readable instructions for:
receiving data corresponding to multi-dimensional images of a patient's lungs;
generating a volumetric model of the patient's airway; and
displaying the volumetric model on a graphical user interface, wherein the model includes sublobes of the patient's lungs.

14. The computer readable medium of claim 13 wherein the computer readable-medium further comprises instructions for displaying multi-dimensional images of the patient's lungs on the graphical user interface.

15. The computer readable medium of claim 14 wherein the computer readable-medium further comprises instructions for:
receiving user input identifying a location on the volumetric model or on a multi-dimensional image on the graphical user interface;
altering the volumetric model to highlight a portion of the airway tree, that portion being all of the airway distal to the user identified location; and
altering the multi-dimensional images to highlight the portion of the airway tree;
wherein the portion of the airway tree is a sublobe.

16. The computer readable medium of claim 15 wherein the computer readable medium further comprises instruction for calculating data corresponding the to the portion of the airway tree and displaying the data on the graphical user interface.

17. The computer readable medium of claim 16 wherein the data comprises volume and/or density.

18. A method of visualizing a sublobe of a patient comprising:
providing multi-dimensional imaging data of the patient's lungs to a system, the system comprising:
a graphical user interface;
a processor; and
software operable on the processor, wherein the software receives the data from the multi-dimensional images of the patient's lungs and produces data for creation of a volumetric model of the patient's lungs on the graphical user interface, wherein the volumetric model includes sublobar airways.

19. The method of claim 18, further comprising:
selecting a location on the volumetric model, wherein the system is adapted to highlight a portion of the lung distal to the user selected location on the volumetric model, and wherein the highlighted portion of the lung is a sublobe.

20. The method of claim 19 wherein the system is further adapted to provide data on the graphical user interface regarding the highlighted region of the lung.
